(19) United States
(12) Patent Application Publication
(10) Pub. No.: US 2010/0214891 A1
(43) Pub. Date: Aug. 26, 2010

(54) OPTICAL PICKUP DEVICE, OPTICAL DISC DEVICE, COMPUTER, OPTICAL DISC PLAYER, AND OPTICAL DISC RECORDER

(76) Inventors: Joji Anzai, Osaka (JP); Kousei Sano, Osaka (JP); Eishin Mori, Osaka (JP); Hideki Aikoh, Osaka (JP); Hirotaka Ueno, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/681,457

(22) PCT Filed: Oct. 2, 2008
(86) PCT No.: PCT/JP2008/002775

§ 371 Date: Apr. 2, 2010

(30) Foreign Application Priority Data
Oct. 4, 2007 (JP) 2007-260705

(51) Int. Cl. G11B 7/135; G11B 7/00; G11B 19/00

(52) U.S. Cl. 369/47.36; 369/100; 369/112.24; G9B/7; G9B/19; G9B/7.112

(57) ABSTRACT

A first light source 1a emits a first light flux with a first wavelength. A second light source 1b emits a second light flux with a second wavelength that is different from the first wavelength and a third light flux with a third wavelength that is different from the first wavelength and the second wavelength. A collimator lens 6, a first objective lens 9, and a second objective lens 10 collect the first to third light fluxes as converged light on an optical disc. A first composite photodetector 13 detects the reflected light fluxes from the optical disc. The first composite photodetector 13 includes a first quartered light-receiving unit 13a that receives a light flux obtained by reflection of at least one light flux from among the first to third light fluxes from the optical disc and a second quartered light-receiving unit 13b that receives a light flux obtained by reflection of the remaining light fluxes from the optical disc. Such configuration ensures compatibility with optical discs of at least three kinds and enables miniaturization.

### TECHNICAL FIELD

The present invention relates to an optical pickup device that optically records information on and reproduces information from an optical information recording medium such as optical discs of various kinds, an optical disc device equipped with the optical pickup device, and a computer, an optical disc player, and an optical disc recorder equipped with the optical disc device.

### BACKGROUND ART

As blue-violet semiconductor lasers have started finding practical use, Blu-ray discs (referred to hereinbelow as BD), which are high-density and high-capacity optical information recording medium (referred to hereinbelow as “optical disc”) of the same size as a CD (Compact disc) and DVD (Digital Versatile Disc), have also found use. A BD is an optical disc that records and reproduces information by using a blue-violet laser beam source.

A CD is an optical disc that has a transparent substrate thickness of 1.2 mm, a wavelength of a laser beam that records or reproduces information of about 780 nm, a numerical aperture (NA) of an objective lens of 0.45 to 0.55, and a recording capacity of about 650 MByte.

In order to record or reproduce information on or from an optical disc of higher density, it is necessary to reduce further the optical spot diameter that is obtained by converging with the objective lens. In order to reduce the optical spot diameter, it is necessary to shorten the wavelength λ and increase the numerical aperture of the objective lens.

Where the numeral aperture of the objective lens is increased, coma aberration generated due to the inclination of the transparent substrate increases proportionally to a third power of the numerical aperture. Because the coma aberration is proportional to the transparent substrate thickness, the transparent substrate thickness may be reduced to inhibit the coma aberration.

A DVD is an optical disc with a transparent substrate thickness of 0.6 mm, a wavelength of a laser beam that records or reproduces information of about 650 nm, a numerical aperture of an objective lens of 0.60 to 0.65, and a one-layer recording capacity of about 4.7 GByte. In a DVD, the total thickness of the optical disc is obtained to be equal to that of CD, that is, 1.2 mm, by laminating two substrates, each having a thickness of 0.6 mm.

Further, a BD is an optical disc with a transparent substrate thickness of 0.1 mm, a wavelength of a laser beam that records or reproduces information of about 405 nm, a numerical aperture of an objective lens of 0.85, and a one-layer recording capacity of about 25 GByte. In a BD, a recording layer is provided on a disk substrate with a thickness of 1.1 mm, and a transparent cover layer with a thickness of 0.1 mm is attached so as to cover the recording layer. As a result, the total thickness of the optical disc is equal to that of CD, that is, 1.2 mm. Recording on the recording layer or reproduction therefrom are conducted by converging a laser beam on the recording layer from a transparent cover layer side. In a BD, the increase in coma aberration caused by using a short-wavelength laser beam and a high-NA objective lens is inhibited by reducing the thickness of the transparent cover layer through which the laser beam passes to about 0.1 mm.

As described hereinabove, presently there are optical discs of different configurations, such as CD, DVD, and BD. Accordingly, an optical pickup device compatible with such optical discs of different configurations have been provided in which information is recorded or reproduced by converging laser beams of three different wavelengths by using a plurality of objective lenses.

For example, Patent Literature 1 discloses an optical pickup device that can be adapted to optical discs of three kinds, namely, CD, DVD, and BD, by combining two objective lenses with two optical systems.

FIG. 13A shows a schematic configuration of the conventional optical pickup device. FIG. 13B is a side view of the vicinity of the objective lens in the convention optical pickup. In the optical pickup device 100 of a three-wavelength adaption type shown in FIG. 13A, optical elements are placed on a base 111. An optical system in the optical pickup device 100 is constituted by a CD/DVD optical system 120 for recording information on or reproducing information from CD and DVD, a BD optical system 140 for recording information on or reproducing information from BD, and a common optically system 160 that can be commonly used with each of CD, DVD, and BD.

In the CD/DVD optical system 120, a laser beam (emitted beam for CD/DVD) emitted from a CD/DVD laser diode 121 falls on a collimator lens 126 after passing through a coupling lens 122, a mirror 123, a grating 124, and a beam splitter 125 in the order of description. The collimator lens 126 converts the emitted beam for CD/DVD into a parallel beam. The emitted beam for CD/DVD that has been converted into the parallel beam falls on the common optical system 160.

The beam splitter 161 for combining optical paths of the common optical system 160 partially reflects the emitted beam for CD/DVD at a right angle. The reflected part of the emitted beam for CD/DVD falls on a front photodiode 127 for laser power detection. Further, in the common optical system 160, the remainder of the emitted beam for CD/DVD illuminates the recording surface of the optical disc 101 via the CD/DVD objective lens 162. The reflected light from the recording surface is received as incident beam for CD/DVD by the CD/DVD objective lens 162 and emitted towards the CD/DVD optical system 120.

In the CD/DVD optical system 120, the incident beam for CD/DVD falls on the beam splitter 125 via the collimator lens 126. The beam splitter 125 reflects the incident beam for CD/DVD at a right angle. The reflected incident beam for CD/DVD falls on a PDIC (Photo Detector IC) 130 for detection via a cylindrical lens 128 and a hologram 129. The PDIC 130 photo electrically converts the incident beam for CD/DVD and outputs various signals such as a reproduction signal, a tracking error signal, and a focus error signal.

Meanwhile, in the BD optical system 140, the polarization plane of a laser beam (emitted beam for BD) emitted from a BD laser diode 141 is rotated by a polarization means 142 that is a wavelength plate, a grating, or composite element thereof and then falls on a beam splitter 143.

The beam splitter 143 transmits part of the emitted beam for BD. The transmitted part of the emitted beam for BD falls on a front photodiode 145 for laser power detection via a collimator lens 144. Further, the beam splitter 143 reflects the remainder of the emitted beam for BD. The reflected remainder of the emitted beam for BD falls on a collimator lens 148 via a beam splitter 146 and a mirror 147 in the order of description. The collimator lens 148 converts the emitted beam for BD into a parallel beam. The emitted beam for BD that has been converted into a parallel beam falls on the common optical system 160.

A beam splitter 161 for combining optical paths of the common optical system 160 reflects the emitted beam for BD at a right angle. The reflected emitted beam for BD illuminates a recording surface of the optical disc 101 via a BD objective lens 163. The reflected beam from the recording surface is received as an incident beam for BD by the BD objective lens 163 and emitted towards the BD optical system 140.

In the BD optical system 140, the incident beam for BD falls on the beam splitter 146 via the collimator lens 148 and mirror 147 in the order of description. The beam splitter 146 transmits the incident light for BD. The transmitted incident light for BD falls on the PDIC 151 for detection via the hologram 149 and coupling lens 150. The PDIC 151 photoelectrically converts the incident beam for BD and outputs various signals such as a reproduction signal, a tracking error signal, and a focus error signal.

The configuration of the common optical system 160, which is a specific feature of the conventional technology, will be explained below in greater detail. In the common optical system 160, the CD/DVD objective lens 162 and BD objective lens 163 are installed on the same two-axis actuator 168, and a raising mirror unit 165 composed of a CD/DVD raising mirror 166 and a BD raising mirror 167 is provided below the CD/DVD objective lens 162 and BD objective lens 163.

Thus, as shown in FIG. 13B, the CD/DVD raising mirror 166 is provided below the CD/DVD objective lens 162, and the BD raising mirror 167 is provided below the BD objective lens 163. The beam splitter 161 for combining optical paths, BD raising mirror 167, and CD/DVD raising mirror 166 are disposed on the same straight line.

As described hereinabove, in the common optical system 160, the emitted beam for CD/DVD and the emitted beam for BD both fall on the beam splitter 161 for combining optical paths. The emitted beam for CD/DVD and the emitted beam for BD that have been transmitted by the beam splitter 161 for combining optical paths are caused by the common optical system 160 to fall on the BD raising mirror 167 via a liquid crystal element 164 for astigmatism correction.

The BD raising mirror 167 is constituted by a wavelength-selective beam splitter and rotates through 90° only the blue laser beam with a wavelength of 405 nm for a Blu-ray disk. Therefore, in a case where the incident emitted beam is the emitted beam for BD, the BD raising mirror 167 reflects the emitted beam for BD, raises the beam up, illuminates the optical disc 101 (in this case, a BD) via the BD objective lens 163, and reflects the incident light for BD that has been received via the BD objective lens 163. The reflected incident light for BD falls on the BD optical system 140 via the liquid crystal element 164 and beam splitter 161 for combining optical paths.

By contrast, when the incident emitted beam is the emitted beam for CD/DVD, the BD raising minor 167 transmits the emitted beam for CD/DVD and causes this beam to fall on the CD/DVD raising mirror 166. The CD/DVD raising mirror 166 reflects the emitted beam for CD/DVD, raises the beam up, illuminates the optical disc 101 (in this case, a CD or DVD) via the CD/DVD objective lens 162, and reflects the incident light for CD/DVD that has been received via the CD/DVD objective lens 162. The reflected incident light for CD/DVD falls on the CD/DVD optical system 120 via the BD raising mirror 167, liquid crystal element 164, and beam splitter 161 for combining optical paths.

In the above-described configuration, in the optical pickup device 100, the CD/DVD objective lens 162 and BD objective lens 163 are installed on the same two-axis actuator 168, and the emitted beam for CD/DVD, which is emitted from the CD/DVD optical system 120, and the emitted beam for BD, which is emitted from the BD optical system 140, fall together on the raising mirror unit 165 via the beam splitter 161 for combining optical paths of the common optical system 160.

The emitted beam for CD/DVD and emitted beam for BD are then separated by the BD raising mirror 167 constituted by a wavelength-selective beam splitter and emitted via the corresponding CD/DVD objective lens 162 or BD objective lens 163.

Thus, the emitted beam for CD/DVD and emitted beam for BD at the time of falling on the raising mirror unit 165 are combined by the beam splitter 161 for combining optical paths, thereby producing a common optical path for the emitted beam for CD/DVD and emitted beam for BD with respect to the two-axis actuator 168 that holds the CD/DVD objective lens 162 and BD objective lens 163. As a result, the optical pickup device 100 of a three-wave adaption type can be configured by using the two-axis actuator 168 of a thin structure with a limited laser beam introduction range.

However, with the configuration such as described in the conventional example, a respective collimator lens, a detector, and a plurality of optical elements for guiding light to the detector are necessary for the BD optical system and CD/DVD optical system. The resultant problem is that the optical pickup device has a complex configuration unsuitable for miniaturization and cost reduction.

### Patent Literature 1: Japanese Patent Application Laid-Open No. 2006-134474

### DISCLOSURE OF THE INVENTION

The present invention has been created to resolve the above-described problems and it is an object of the present invention to provide an optical pickup device, an optical disc device, a computer, an optical disc player, and an optical disc recorder that are compatible with optical information recording media of at least three kinds and make it possible to realize size reduction.

The optical pickup device according to one aspect of the present invention is an optical pickup device that reproduces or records information from or on optical information recording media of at least three kinds, including: a first light source that emits a first light flux with a first wavelength; a second light source that emits a second light flux with a second wavelength that is different from the first wavelength and a third light flux with a third wavelength that is different from the first wavelength and the second wavelength; a light collection unit that collects the first to third light fluxes as converged light on the optical information recording medium, and a detection unit that detects the reflected light fluxes from the optical information recording medium, wherein the detection unit includes a first quartered light-receiving unit that receives a light flux obtained by reflection of at least one light flux from among the first to third light fluxes from the optical information recording medium and a second quartered light-receiving unit that receives a light flux obtained by reflection of the remaining light fluxes from the optical information recording medium.

With such a configuration, a first light flux with a first wavelength is emitted by the first light source, and a second light flux with a second wavelength that is different from the first wavelength and a third light flux with a third wavelength that is different from the first wavelength and the second wavelength is emitted by the second light source. The light collection unit collects the first to third light fluxes as converged light on the optical information recording medium, and the detection unit detects the reflected light fluxes from the optical information recording medium. Further, the detection unit includes the first quartered light-receiving unit and the second quartered light-receiving unit. The first quartered light-receiving unit receives the light flux obtained by reflection of at least one light flux from among the first to third light fluxes from the optical information recording medium, and the second quartered light-receiving unit receives the reflected light flux from the optical information recording medium of the remaining light fluxes.

In accordance with the present invention, the optical system from the stage of collecting the first to third light fluxes as converged light on the optical information recording medium to the stage of detecting the reflected light beams from the optical information recording medium and the detector that detects the reflected light fluxes can be commonly used with the first to third light fluxes. Therefore, the number of components can be greatly reduced, the device can be made compatible with optical discs of at least three kinds, and size reduction can be realized.

The objects, features, and advantages of the present invention will be made clear by the following detailed description and appended drawings.

### BRIEF DESCRIPTION OF THE DRAWINGS

FIG. 1 shows a schematic configuration of an optical pickup device in Embodiment 1 of the present invention.

FIG. 2 is a side view of the vicinity of the objective lens of the optical pickup device shown in FIG. 1.

FIG. 3 is a schematic diagram illustrating a spot shape on a quartered light-receiving pattern in the first composite photodetector of the light beam reflected by the BD, DVD, and CD.

FIG. 4 illustrates the relationship between light beams falling on the first and second raising mirrors and the light beams falling on the first and second objective lenses.

FIG. 5 is a schematic diagram illustrating another example of spot shape of the light beam in the first composite photodetector.

FIG. 6 shows a schematic configuration of the optical pickup device in the first variation example of Embodiment 1.

FIG. 7 shows a schematic configuration of the optical pickup device in the second variation example of Embodiment 1.

FIG. 8 shows a schematic configuration of the optical pickup device in the third variation example of Embodiment 1.

FIG. 9 shows a schematic configuration of an optical disc device in Embodiment 2 of the present invention.

FIG. 10 shows a schematic configuration of a computer in Embodiment 3 of the present invention.

FIG. 11 shows a schematic configuration of an optical disc player in Embodiment 4 of the present invention.

FIG. 12 shows a schematic configuration of an optical disc recorder in Embodiment 5 of the present invention.

FIG. 13A shows a schematic configuration of the conventional optical pickup device.

FIG. 13B is a side view of the vicinity of objective lens in the conventional optical pickup device.

### BEST MODE FOR CARRYING OUT THE INVENTION

The embodiments of the present invention will be explained below with reference to the appended drawings. The below-described embodiments are merely specific examples of the invention and are not intended to limit the technical scope of the invention.

### Embodiment 1

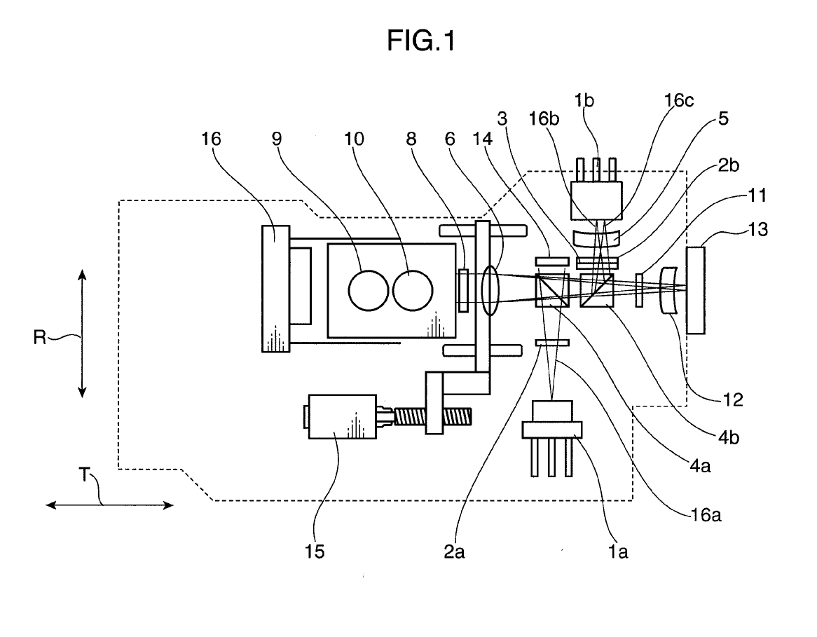

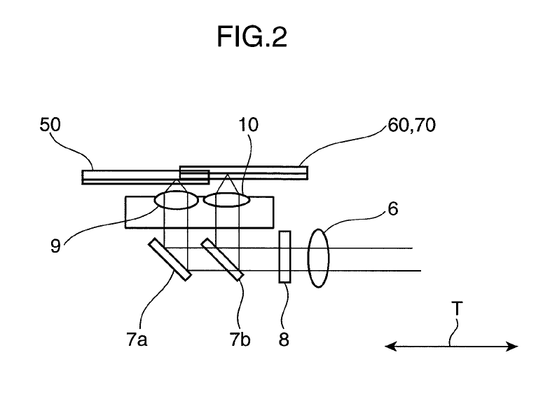

FIG. 1 shows a schematic configuration of an optical pickup device in Embodiment 1 of the present invention. FIG. 2 is a side view of the vicinity of the objective lens of the optical pickup device shown in FIG. 1.

Referring to FIG. 1 and FIG. 2, the optical pickup device includes a first light source 1a, a second light source 1b, λ/2 plates 2a, 2b, a diffraction grating 3, a first prism 4a, a second prism 4b, a coupling lens 5, a collimator lens 6, a first raising mirror 7a, a second raising mirror 7b, a λ/4 plate 8, a first objective lens 9, a second objective lens 10, a detection diffraction element 11, a detection lens 12, a first composite photodetector 13, a second composite photodetector 14, a collimator lens actuator 15, and an objective lens actuator 16.

The first light source 1a emits a first light flux with a first wavelength. The second light source 1b emits a second light flux that has a second wavelength different from the first wavelength and a third light flux that has a third wavelength different from the first wavelength and the second wavelength. The second light source 1b is constituted by a single light-emitting element that emits the second light flux and the third light flux. In this case, the size of the optical pickup device can be reduced with respect to that in a case where the light source emitting the red light beam and the light source emitting the infrared light beam are constituted by different light-emitting elements.

The first wavelength is 380 to 430 nm, and the first light flux is a blue-violet light beam. The second wavelength is 640 to 690 nm, and the second light flux is a red light beam. The third wavelength is 750 to 820 nm and the third light flux is an infrared light beam.

The first light source 1a emits a blue-violet laser beam. The second light source 1b emits laser beams of two wavelengths: a red laser beam and an infrared laser beam. The λ/2 plates 2a, 2b rotate a linearly polarized light. With some polarization directions of the first light source 1a, λ/2 plate 2a can be omitted. The diffraction grating 3 generates a diffraction light for generating a tracking error signal by a DPP (Differential Push-Pull) method.

The first prism 4a operates as a polarizing beam splitter (PBS) that almost completely transmits a polarized light A (polarized light in the direction parallel to the paper surface in FIG. 1), reflects a polarized light B (polarized light in the direction perpendicular to the paper surface in FIG. 1) at almost 90%, and transmits the remaining light with respect to the blue-violet light beam. The first prism 4a has a property of reflecting part of the polarized light B and transmitting the remaining light with respect to the red light beam and infrared light beam.

The second prism 4b operates as a PBS that almost completely reflects the polarized light B and almost completely transmits the polarized light A with respect to the red light beam and infrared light beam. The second prism 4b also has a property of almost entirely transmitting the blue-violent laser beam.

The first prism 4a reflects the blue-violet light beam emitted from the first light source 1a and transmits the light flux of the blue-violet light beam reflected from an optical disc (BD 50), and also reflects the red light beam or infrared light beam emitted from the second light source 1b and transmits the light flux of the red light beam or infrared light beam reflected from an optical disc (DVD 60 or CD 70).

In this case, the blue-violet light beam, red light beam, and infrared light beam emitted by the first and second light sources 1a, 1b can be guided in the same direction, and the light beams obtained by reflection of the blue-violet light beam, red light beam, and infrared light beam from the BD 50, DVD 60, and CD 70 can be guided to the first composite photodetector 13.

When a prism is caused to transmit a blue-violet light beam, an adhesive present at a prism interface portion is typically damaged and optical characteristics of the prism are deteriorated. However, in Embodiment 1, the first light source 1a is disposed on the objective lens side, and the first prism 4a reflects the blue-violet light beam of high intensity when light is emitted. Therefore, long service life of the first prism 4a can be realized.

The coupling lens 5 sets the desirable light collection degree of the red light beam and infrared light beam emitted from the second light source 1b. The collimator lens 6 makes the blue-violet light beam, red light beam, and infrared light beam almost parallel. The first raising mirror 7a guides the blue-violet light beam to the first objective lens 9. The second raising mirror 7b guides the red light beam and infrared light beam to the second objective lens 10. The second raising mirror 7b also has a wavelength selective characteristic and almost entirely transmits the blue-violet light beam.

The first raising mirror 7a reflects the blue-violet light beam. The second raising mirror 7b transmits the blue-violet light beam and reflects the red light beam and infrared light beam. The first raising mirror 7a and second raising mirror 7b are disposed so that the reflective planes thereof have a predetermined relative angle (this will be described below in greater detail).

The λ/4 plate 8 converts a linearly polarized light into a circularly polarized light. The first objective lens 9 is adapted to the blue-violet light beam and collects the blue-violet light beam on the optical disc (BD 50). The second objective lens 10 is adapted to the red light beam and infrared light beam, collects the red light beam on the optical disc (DVD 60) and collects the infrared light beam on the optical disc (CD 70). The detection diffraction element 1 splits the light flux to detect a servo signal. The detection lens 12 imparts astigmatism to the light flux.

The first composite photodetector 13 has two quartered light-receiving units and detects the light beams obtained by reflection of the blue-violet light beam, red light beam, and infrared light beam from the optical discs. The second composite photodetector 14 monitors the laser output of all the light beams, that is, the blue-violet light beam, red light beam, and infrared light beam.

Referring to FIG. 1, the second composite photodetector 14 detects the blue-violet light beam that has been transmitted by the first prism 4a, the red light beam that has been reflected by the first prism 4a, and the infrared light beam that has been reflected by the first prism 4a, but the present invention is not limited to this configuration. The second composite photodetector 14 may be also disposed along the optical axis of the light beam falling on the first raising mirror 7a and second raising mirror 7b.

In this case, the first raising mirror 7a and second raising mirror 7b will transmit parts of the blue-violet light beam, red light beam, and infrared light beam. Parts of the blue-violet light beam, red light beam, and infrared light beam that have been transmitted by the first raising mirror 7a and second raising mirror 7b fall on the second composite photodetector 14. The second composite photodetector 14 detects the blue-violet light beam, red light beam, and infrared light beam that have been transmitted by the first raising mirror 7a and second raising mirror 7b.

Thus, even in a case in which the second composite photodetector 14 is difficult to dispose in the vicinity of the first prism 4a, the laser output of the light beam can be monitored by disposing the second composite photodetector 14 in the vicinity of the first raising mirror 7a.

Further, in the present embodiment, the first raising mirror 7a and second raising mirror 7b have a flat shape. However, where the second composite photodetector 14 is disposed in the vicinity of the first raising mirror 7a, it is preferred that the first raising mirror 7a and second raising mirror 7b have a wedge-like shape. As a result, interference caused by the first raising mirror 7a and second raising mirror 7b can be prevented and detection accuracy of the second composite photodetector 14 can be increased.

The collimator lens actuator 15 moves the collimator lens 6 in the optical axis direction. The objective lens actuator 16 shifts the first objective lens 9 and second objective lens 10 in the light collection direction and tracking direction. In FIG. 1 and FIG. 2, an arrow R shows a radial direction that is a radial direction of the optical disc, and an arrow T shows a tangential direction that is a tangential direction of the optical disc.

The BD 50 is an optical disc in which information is reproduced or recorded by a blue-violet light beam. The DVD 60 is an optical disc in which information is reproduced or recorded by a red light beam. The CD 70 is an optical disc in which information is reproduced or recorded by an infrared light beam.

An optical pickup device of the present embodiment records information on the BD 50, DVD 60, or CD 70 or reproduces information therefrom.

In Embodiment 1, the blue-violet light beam corresponds to an example of the first light flux, the red light beam corresponds to an example of the second light flux, and the infrared light beam corresponds to an example of the third light flux. The BD 50, DVD 60, and CD 70 correspond to examples of optical information recording medium. The first prism 4a, second prism 4b, collimator lens 6, first raising mirror 7a, second raising mirror 7b, first objective lens 9, and second objective lens 10 correspond to examples of light collection units. The first composite photodetector 13 corresponds to an example of the detection unit, the first raising mirror 7a corresponds to an example of the first mirror, the second raising mirror 7b corresponds to an example of the second mirror, and the first prism 4a corresponds to an example of the light dividing element.

The operation of the optical pickup device in a case where information is recorded on the BD 50 and reproduced therefrom will be described below with reference to FIG. 1 and FIG. 2.

A blue-violet light beam 16a emitted from the first light source 1a is converted into the polarized light B by the λ/2 plate 2a. About 90% of the blue-violet light beam 16a that has been transmitted by the λ/2 plate 2a is reflected by the first prism 4a and falls on the collimator lens 6. The remainder is transmitted by the first prism 4a and falls on the second composite photodetector 14. The second composite photodetector 14 detects the light quantity of the blue-violet light beam 16a emitted from the first light source 1a. The detected light quantity is used to control the light quantity of the first light source 1a.

The transmitted blue-violet light beam 16a is converted into an approximately parallel light beam by the collimator lens 6. The blue-violet light beam 16a converted into an approximately parallel light beam by the collimator lens 6 is converted into a circularly polarized light by the λ/4 plate 8 and transmitted by the second raising mirror 7b. The blue-violet light beam 16a that has been transmitted by the second raising mirror 7b is almost entirely reflected by the first raising mirror 7a and falls on the first objective lens 9. The collimator lens 6 is held in the lens holder of the collimator lens actuator 15 and can be moved along the optical axis of the light beam by a stepping motor. The blue-violet light beam 16a that has fallen on the first objective lens 9 is converged as a light spot on the information recording plane of the BD 50 over the transparent substrate.

When the light spot is converged on the information recording plane of the BD 50, spherical aberration is generated by a thickness error of the transparent substrate of the BD 50. The spherical aberration can be corrected by converting the laser beam falling onto the first objective lens 9 into diverging light or converging light and generating a spherical aberration of polarity reversed with respect to that of the spherical polarity generated correspondingly to the thickness of the transparent substrate. For example, the collimator lens actuator 15 is used as shown in FIG. 1 and the collimator lens 6 is moved back and forth in the optical axis direction. As a result, the laser beam falling onto the first objective lens 9 is converted into diverging light or converging light, a spherical aberration of inverse polarity is generated by the first objective lens 9, and the spherical aberration caused by the thickness error of the transparent substrate is canceled.

By transmitting the blue-violet light beam 16a on a return path that is reflected by the information recording surface of the BD 50 through the λ/4 plate 8, the circularly polarized light is converted into the polarized light A (orthogonal to the polarized light B at a time of falling on the λ/4 plate 8 in the outward path), which is a linearly polarized light. The blue-violet light beam 16a converter into the linearly polarized light is converted by the collimator lens 6 from an almost parallel beam into a converging beam that is transmitted by the first prism 4a and second prism 4b, and the light flux splitting is performed for detecting the servo signal in the detection diffraction element 11. Then, the blue-violet light beam 16a is provided with a predetermined astigmatism by the detection lens 12 and guided to the first composite photodetector 13. The first composite photodetector 13 generates an information signal and a servo signal on the basis of the detected blue-violet light beam 16a.

The operation of the optical pickup device in a case where information is recorded on the DVD 60 or reproduced therefrom will be described below with reference to FIG. 1 and FIG. 2.

A red light beam 16b emitted from the second light source 1b is transmitted by the coupling lens 5 and then converted into the polarized light B by the λ/2 plate 2b. The red light beam 16b that has been transmitted by the λ/2 plate 2b passes through the diffraction grating 3. The diffraction grating 3 generates diffracted light for generating a tracking error signal by the DPP method. The red light beam 16b that has passed through the diffraction grating 3 is entirely reflected by the second prism 4b and falls on the first prism 4a. About 90% of the red light beam 16b is transmitted by first prism 4a and falls on the collimator lens 6. The remainder is reflected by the first prism 4a and falls on the second composite photodetector 14. The second composite photodetector 14 detects the light quantity of the red light beam 16b emitted from the second light source 1b. The detected light quantity is used to control the light quantity of the second light source 1b.

The transmitted red light beam 16b is converted into an approximately parallel light beam by the collimator lens 6. The red light beam 16b converted into an approximately parallel light beam by the collimator lens 6 is converted into a circularly polarized light by the λ/4 plate 8 and reflected by the second raising mirror 7b and then falls on the second objective lens 10. The red light beam 16b that has fallen on the second objective lens 10 is converged as a light spot on the information recording plane of the DVD 60 over the transparent substrate.

Since the red light beam 16b on a return path that is reflected by the information recording surface of the DVD 60 is transmitted through the λ/4 plate 8, the circularly polarized light is converted into the polarized light A, which is a linearly polarized light. The red light beam 16b converted into the linearly polarized light is converted by the collimator lens 6 from an almost parallel beam into a converging beam that is transmitted by the first prism 4a and second prism 4b, provided with the predetermined astigmatism by the detection lens 12 and guided to the first composite photodetector 13. The first composite photodetector 13 generates an information signal and a servo signal on the basis of the detected red light beam 16b.

The operation of the optical pickup device in a case where information is recorded on the CD 70 and reproduced therefrom will be described below with reference to FIG. 1 and FIG. 2.

Where an infrared laser beam is emitted from the second light source 1b that emits laser beams of two wavelengths, it is possible to record information on the CD 70 or reproduce information therefrom. Because the operation of the optical pickup device in case of recording information on the CD 70 or reproducing information therefrom is identical to that in the case in which information is recorded on the DVD 60 or reproduced therefrom, as described with reference to FIG. 1 and FIG. 2, detailed explanation thereof is omitted.

Referring to FIG. 1, the first objective lens 9 and second objective lens 10 are installed on the objective lens actuator 16. The objective lens actuator 16 causes the first objective lens 9 and second objective lens 10 to track surface unevenness of the BD 50, DVD 60, and CD 70 and eccentricity of information tracks.

In order to make the second objective lens 10 adaptive to DVD 60 and CD 70, a blazed diffraction structure with a sawtooth cross section is formed at least one surface from among the incoming surface and outgoing surface of the second objective lens 10, for example, in the present embodiment, on the incoming surface (surface on the light source side) of the second objective lens 10. The blazed diffraction structure conducts aberration correction so as to converge the laser beams of each wavelength to a diffraction limit in the DVD 60 and CD 70 that perform recording or reproduction by laser beams of respective wavelengths by matching the diffraction power of the second objective lens 10.

The second objective lens 10 thus provided with the blazed diffraction structure that diffracts part of the incident light can form a light spot of a respective diffraction limit on the optical discs with different substrate thickness. Further, a region for converging the infrared laser beam on the CD 70 is designed to be limited by the central portion of the second objective lens 10 including the optical axis, and a region for converting the red laser beam on the DVD 60 is designed to use both the central portion and the outer circumferential portion of the second objective lens 10. As a result, the NA of the second objective lens 10 with respect to the CD 70 can be restricted to about 0.45, and the NA of the second objective lens 10 with respect to the DVD 60 can be expanded to about 0.65.

A focus error signal of the BD 50, DVD 60, and CD 70 is detected by using the so-called astigmatism method by which a focused spot provided with astigmatism by the detection lens 12 is detected correspondingly to a quartered light-receiving pattern in the first complex photodetector 13. The information recorded on the BD 50, DVD 60, and CD 70 is detected by adding the outputs of light-receiving units of the quartered light-receiving unit.

Further, the tracking error signal of the BD 50 is detected by using a +1-order diffraction beam generated by the detection diffraction element 11. The so-called three-beam method or DPP method in which a diffraction grating is provided between the first light source 1a and the first prism 4a and the tracking error signal is detected by using the main beam and sub-beam generated by the diffraction grating can be also used.

The tracking error signal of the DVD 60 and CD 70 is detected by using the DPP method and by using the ±1-order diffraction beam generated by the diffraction grating 3.

In the explanation above, methods are described for detecting a focus error signal and a tracking error signal of respective optical discs in the optical pickup device of the present embodiment, but the present invention is not limited to these detection methods, and other methods for detecting the focus error signal and tracking error signal can be also applied. As described hereinabove, the optical pickup device of the present embodiment can reduce significantly the number of components, reduce cost, and decrease size by comparison with the conventional optical pickup device.

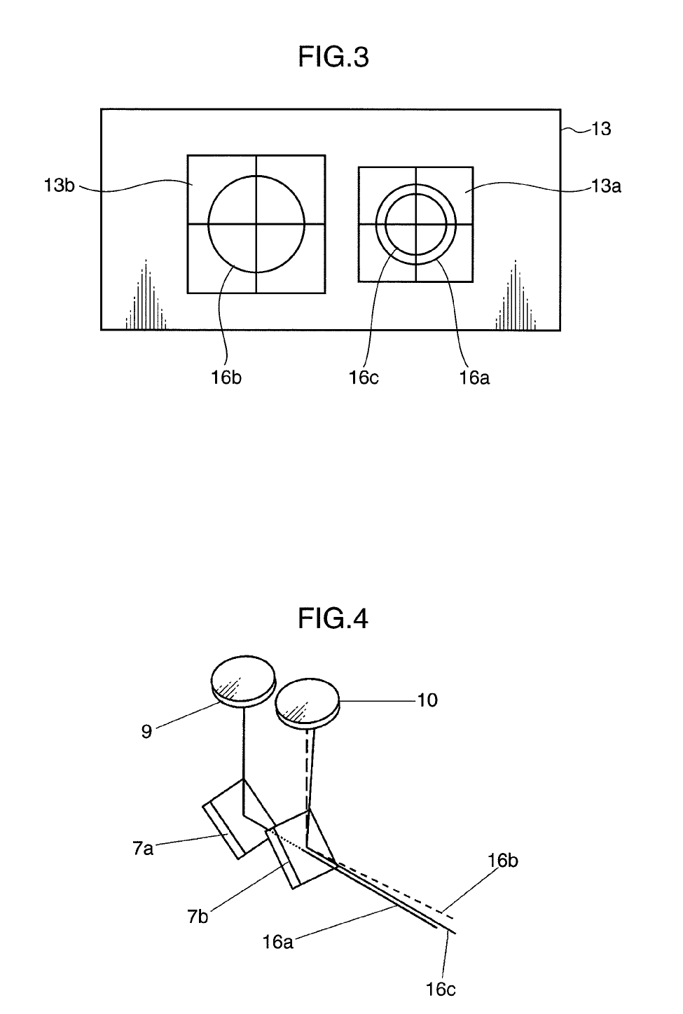

The spot shapes of light beams in the first composite photodetector 13 will be explained below. FIG. 3 is a schematic diagram illustrating the spot shapes on a quartered light-receiving pattern in the first composite photodetector 13 for light beams reflected by the BD 50, DVD 60, and CD 70.

A semiconductor laser of the so-called monolithic structure in which light-emitting points of the emitted red light beam 16b and infrared light beam 16c are shifted in plane with respect to each other is used in the second light source 1b of the present embodiment. In this case, the emitted red light beam 16b and infrared light beam 16c that are reflected by the DVD 60 and CD 70 and fall on the first composite photodetector 13 have different positions in the plane of the first composite photodetector 13, as shown in FIG. 3.

In the present embodiment, the configuration is such that the blue-violet light beam 16a, which is the reflected beam of the BD 50, and the infrared light beam 16c, which is the reflected beam of the CD 70, are received by the same first quartered light-receiving unit 13a, and the red light beam 16b, which is the reflected beam of the DVD 60, is received by a separate second quartered light-receiving unit 13b.

Thus, the first composite photodetector 13 includes the first quartered light-receiving unit 13a that receives a light beam obtained by reflection from the BD 50, DVD 60, and CD 70 of at least one from among the blue-violet light beam 16a, red light beam 16b, and infrared light beam 16c, and a second quartered light-receiving unit 13b that receives a light beam obtained by reflection from the BD 50, DVD 60, and CD 70 of other light beams.

More specifically, the first quartered light-receiving unit 13a receives a light beam obtained by reflection from the BD 50 of the blue-violet light beam 16a that has the longest wavelength and a light beam obtained by reflection from the CD 70 of the infrared light beam 16c that has the shortest wavelength, from among the blue-violet light beam 16a, red light beam 16b, and infrared light beam 16c. Further, the second quartered light-receiving unit 13b receives a light beam obtained by reflection from the DVD 60 of the red light beam 16b that has the remaining wavelength.

This is done to obtain an optimum combination when the sizes of light beams 16a to 16c on the first composite photodetector 13 are taken into account. The sizes of light beams 16a to 16c on the first composite photodetector 13 are determined by the focal distance and numerical aperture of the first objective lens 9 and second objective lens 10. In the present embodiment, due to the size of the objective lens and working distance to the optical disc, it is preferred that the focal distance f1 of the first objective lens 9 and the focal distance f2 of the second objective lens 10 satisfy the following condition: f1<f2.

Accordingly, in the present embodiment, the focal distance f of the first objective lens 9 is taken as 1.3, and the focal distance f of the second objective lens 10 is taken as 2.1. In this case, the following sizes of light beams 16a to 16c on the first composite photodetector 13 can be obtained. Thus, where the size of the blue-violet light beam 16a is taken as 100, the size of the red light beam 16b will be 124 and the size of the infrared light beam 16c will be 86. Where the blue-violet light beam 16a and red light beam 16b are assumed to be received by the same quartered light-receiving unit, the relationship between the red light beam 16b that has a large beam diameter and the quartered light-receiving unit has to be found with consideration for the displacement of the quartered light-receiving unit and light beam.

Further, the size of the quartered light-receiving unit is restricted from the standpoint of frequency characteristic and noise. In the present embodiment, the first quartered light-receiving unit 13a is taken as a square with one side of 120 μm with consideration for detecting the signals of the BD 50. When the red light beam 16b is received by such first quartered light-receiving unit 13a, the diameter of the red light beam 16b becomes 80 μm with consideration for spread such as displacement. In this case, the diameter of the blue-violet light beam 16a is 65 μm and the diameter of the infrared light beam is 56 μm. By contrast, where the blue-violet light beam 16a and infrared light beam 16c are received by the first quartered light-receiving unit 13a, as in the present embodiment, the diameter of the blue-violet light beam can be set to 80 μm. In this case, the diameter of the red light beam 16b is about 100 μm, but because the signal band of DVD is narrower than that of BD, the second quartered light-receiving unit 13b that receives the red light beam 16b may be designed to be larger than the first quartered light-receiving unit 13a. The diameter of the infrared light beam 16c is 69 μm.

The advantage of the system in which the blue-violet light beam 16a and infrared light beam 16c are received by the same quartered light-receiving unit, as in the present embodiment, over the system in which the blue-violet light beam 16a and red light beam 16b are received by the same quartered light-receiving unit is that the ability to ensure a certain spot size on the detector with respect to a displacement between the light beam and quartered light-receiving unit caused by changes in temperature and variations with time is improved by 20% or more. Further, because the surface area of the quartered light-receiving unit that receives the blue-violet light beam from the BD can be reduced, a high-quality signal with low noise can be obtained and a useful characteristic can be obtained during reproduction or double-speed reproduction of optical discs with a low reflection ratio.

Further, because the focal distance of the first objective lens 9 is designed to be less than the focal distance of the second objective lens 10, the diameter of light beams 16a to 16c in the first composite photodetector 13 can be optimized. In addition, because the first quartered light-receiving unit 13a is smaller than the second quartered light-receiving unit 13b, the first composite photodetector 13 can be miniaturized.

By contrast, in the system in which the blue-violet light beam 16a and infrared light beam 16c are received by the same quartered light-receiving unit, when the first raising mirror 7a and second raising mirror 7b are disposed parallel to each other, if the blue-violet light beam 16a falls on the first objective lens 9 perpendicular thereto, then the infrared light beam 16c will fall on the second objective lens 10 perpendicular thereto, and the red light beam 16b will fall on the second objective lens 10 in a direction shifted from the perpendicular direction. The characteristic of objective lenses is usually such that the angle of view narrows as the numerical amplitude increases. Therefore, in the second objective lens 10, the angle of view of the red light beam 16b is narrower than that of the infrared light beam 16c, and the red light beam 16b undesirably falls on the second objective lens 10 from the direction shifted from the perpendicular direction.

Accordingly, in the present embodiment, as shown in FIG. 4, the first raising mirror 7a and second raising mirror 7b are disposed so that the reflecting surfaces thereof have a predetermined relative angle. FIG. 4 serves to explain the arrangement of the first raising mirror 7a and second raising mirror 7b. The second raising mirror 7b is disposed with an inclination relative to the first raising mirror 7a. More specifically, the inclination angle of the second raising mirror 7b is set such that the red light beam 16b reflected by the second raising mirror 7b becomes parallel to the blue-violet light beam 16a reflected by the first raising mirror 7a.

As a result, the optical axis of the blue-violet light beam 16a from the first raising mirror 7a to the first objective lens 9 can be made parallel to the optical axis of the red light beam 16b from the second raising mirror 7b to the second objective lens 10, and the optical axis of the blue-violet light beam 16a can be matched with the optical axis of the infrared light beam 16c in the first composite photodetector 13.

As described hereinabove, in the optical pickup device of the present embodiment, highly reliable detection can be conducted, while maintaining the optical characteristics of DVD. In addition, the number of components can be greatly reduced, and the cost and size can be decreased by comparison with those of the conventional optical pickup device.

Further, the optical system (for example, the collimator lens 6) from the stage of collecting the blue-violet light beam, red light beam, and infrared light beam as converged beams on the BD 50, DVD 60, and CD 70 to the stage of detecting the reflected light beams from the BD 50, DVD 60, and CD 70 and the first composite photodetector 13 that detects the reflected light beams can be commonly used with the blue-violet light beam, red light beam, and infrared light beam. Therefore, the number of components can be greatly reduced, the device can be made compatible with optical discs of at least three kinds, and size reduction can be realized.

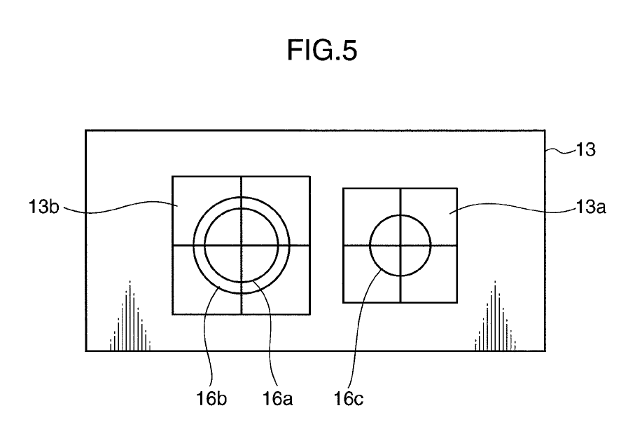

Another example of spot shape of optical beams in the first composite photodetector 13 will be explained below. FIG. 5 is a schematic drawing illustrating another example of spot shape of light beams in the first composite photodetector 13. In Embodiment 1, the blue-violet light beam 16a and infrared light beam 16c are received by the first quartered light-receiving unit 13a, and the red light beam 16b is received by the second quartered light-receiving unit 13b, but the present invention is not limited to this configuration and, as shown in FIG. 5, and the infrared light beam 16c may be received by the first quartered light-receiving unit 13a and the blue-violet light beam 16a and red light beam 16b may be received by the second quartered light-receiving unit 13b. In this case, the first raising mirror 7a and second raising mirror 7b are disposed parallel to each other.

In Embodiment 1, the optical pickup device is described that is compatible with optical discs of three kinds: BD, DVD, and CD, but the present invention is not limited to such a configuration. The optical pickup device may also conduct recording or reproduction of information with respect to optical discs of four kinds, namely, BD, DVD, CD, and HD DVD. In this case, the blue-violet light beam for HD DVD is raised by the second raising mirror 7b and falls on the second objective lens 10. The second objective lens 10 focuses the blue-violet light beam on the HD DVD. Further, the first quartered light-receiving unit 13a of the first composite photodetector 13 receives the blue-violet light beam reflected by the HD DVD.

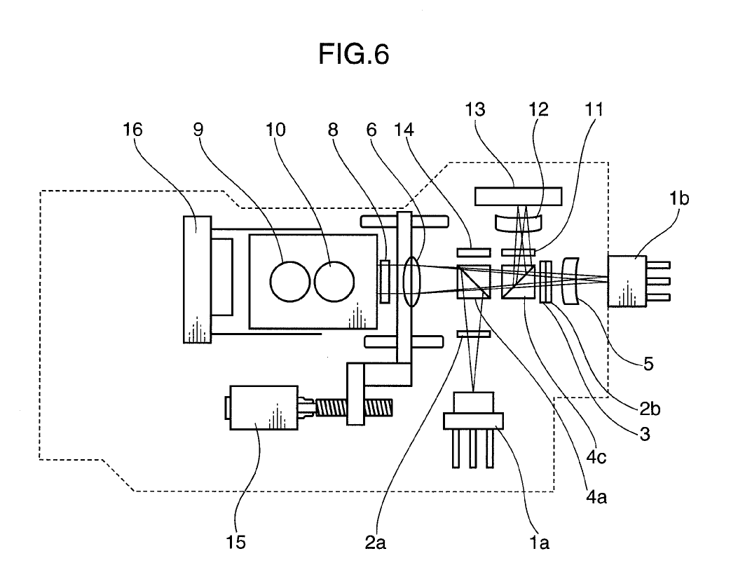

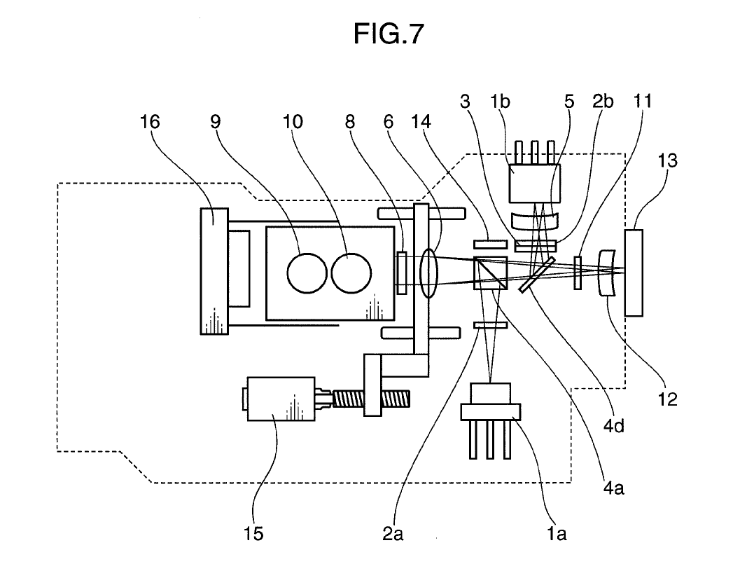

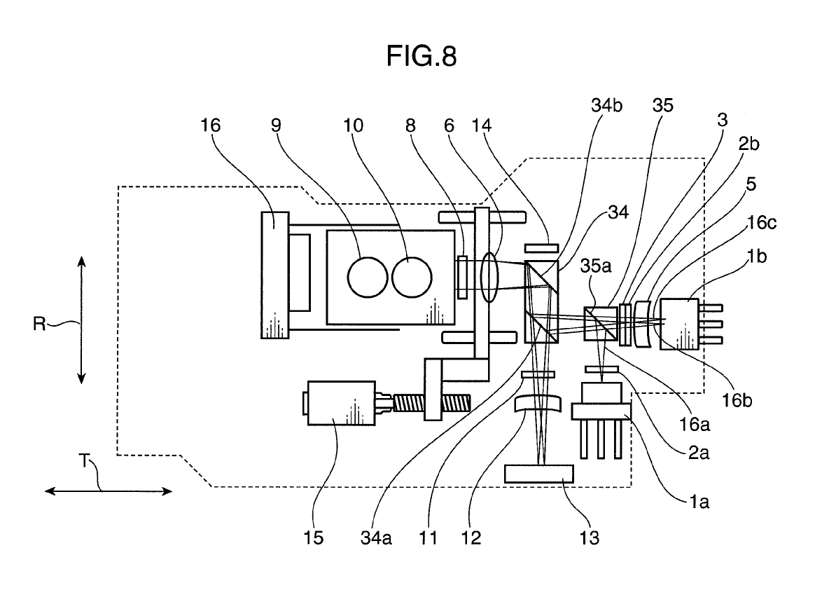

The configurations of the optical pickup device in the first, second, and third variation examples of Embodiment 1 are shown in FIG. 6, FIG. 7, and FIG. 8.

FIG. 6 shows a schematic configuration of the optical pickup device in the first variation example of Embodiment 1. The configuration of the optical pickup device shown in FIG. 6 differs from the configuration of the optical pickup device shown in FIG. 1 in that the second light source 1b changed places with the first composite photodetector 13.

The optical pickup device shown in FIG. 6 includes a first light source 1a, a second light source 1b, λ/2 plates 2a, 2b, a diffraction grating 3, a first prism 4a, a third prism 4c, a coupling lens 5, a collimator lens 6, a first raising mirror 7a, a second raising mirror 7b, a λ/4 plate 8, a first objective lens 9, a second objective lens 10, a detection diffraction element 11, a detection lens 12, a first composite photodetector 13, a second composite photodetector 14, a collimator lens actuator 15, and an objective lens actuator 16. Only the features shown in FIG. 6 that differ from those shown in FIG. 1 will be explained below.

The third prism 4c operates as a PBS that almost completely transmits the polarized light in the direction parallel to the paper surface in FIG. 6 and almost completely reflects the polarized light in the direction perpendicular to the paper surface in FIG. 6 with respect to the red light beam and infrared light beam. Further, the third prism 4c has a property of almost completely reflecting the blue-violet light beam.

Thus, the third prism 4c transmits the red light beam and infrared light beam emitted by the second light source 1b and reflects the blue-violet light beam, red light beam, and infrared light beam reflected by a BD 50, a DVD 60, and a CD 70 toward the first composite photodetector 13.

The optical pickup device shown in FIG. 6 demonstrates an effect similar to that of the optical pickup device shown in FIG. 1.

FIG. 7 shows a schematic configuration of the optical pickup device in the second variation example of Embodiment 1. The configuration of the optical pickup device shown in FIG. 7 differs from the configuration of the optical pickup device shown in FIG. 1 in that the second prism 4b is replaced with a plate-type PBS 4d.

The optical pickup device shown in FIG. 7 includes a first light source 1a, a second light source 1b, λ/2 plates 2a, 2b, a diffraction grating 3, a first prism 4a, a PBS 4d, a coupling lens 5, a collimator lens 6, a first raising mirror 7a, a second raising mirror 7b, a λ/4 plate 8, a first objective lens 9, a second objective lens 10, a detection diffraction element 11, a detection lens 12, a first composite photodetector 13, a second composite photodetector 14, a collimator lens actuator 15, and an objective lens actuator 16. Only the features shown in FIG. 7 that differ from those shown in FIG. 1 will be explained below.

The PBS 4d almost completely reflects the polarized light in the direction parallel to the paper surface in FIG. 7 and almost completely transmits the polarized light in the direction perpendicular to the paper surface in FIG. 7 with respect to the red light beam and infrared light beam. Further, the PBS 4d has a property of almost completely transmitting the blue-violet light beam.

In this case, the transmission ratio to the first composite photodetector 13 is decreased by comparison with that in the case the second prism 4b is used, but the cost is reduced and therefore a less expensive optical pickup device can be realized.

FIG. 8 shows a schematic configuration of the optical pickup device in the third variation example of Embodiment 1. The configuration of the optical pickup device shown in FIG. 8 differs from the configuration of the optical pickup device shown in FIG. 1 in that the first prism 4a and second prism 4b are replaced with a fourth prism 34 and a fifth prism 35.

The optical pickup device shown in FIG. 8 includes a first light source 1a, a second light source 1b, λ/2 plates 2a, 2b, a diffraction grating 3, a fourth prism 34, a fifth prism 35, a coupling lens 5, a collimator lens 6, a first raising minor 7a, a second raising mirror 7b, a λ/4 plate 8, a first objective lens 9, a second objective lens 10, a detection diffraction element 11, a detection lens 12, a first composite photodetector 13, a second composite photodetector 14, a collimator lens actuator 15, and an objective lens actuator 16. Only the features shown in FIG. 8 that differ from those shown in FIG. 1 will be explained below.

The fifth prism 35 has a dichroic film 35a that reflects the blue-violet light beam 16a emitted from the first light source 1a and transmits the red light beam 16b and infrared light beam 16c emitted from the second light source 1b.

The fourth prism 34 has a polarization beam splitter function. The fourth prism 34 has a first dichroic film 34a that reflects the blue-violet light beam 16a, red light beam 16b, and infrared light beam 16c from the first and second light sources 1a and 1b and transmits the reflected light beam from the optical disc and a second dichroic film 34b that transmits part of the blue-violet light beam 16a, red light beam 16b, and infrared light beam 16c reflected by the first dichroic film 34a, reflects the remainders of the light beams, and reflects the reflected light beam from the optical disc.

The optical pickup device shown in FIG. 8 demonstrates an effect similar to that of the optical pickup device shown in FIG. 1.

The configurations of the optical pickup device described in the present embodiment are merely exemplary, and the same effect can be obtained with the configuration in which the first light source 1a changed places with the second light source 1b and the configuration in which the first objective lens 9 changed places with the second objective lens 10.

### Embodiment 2

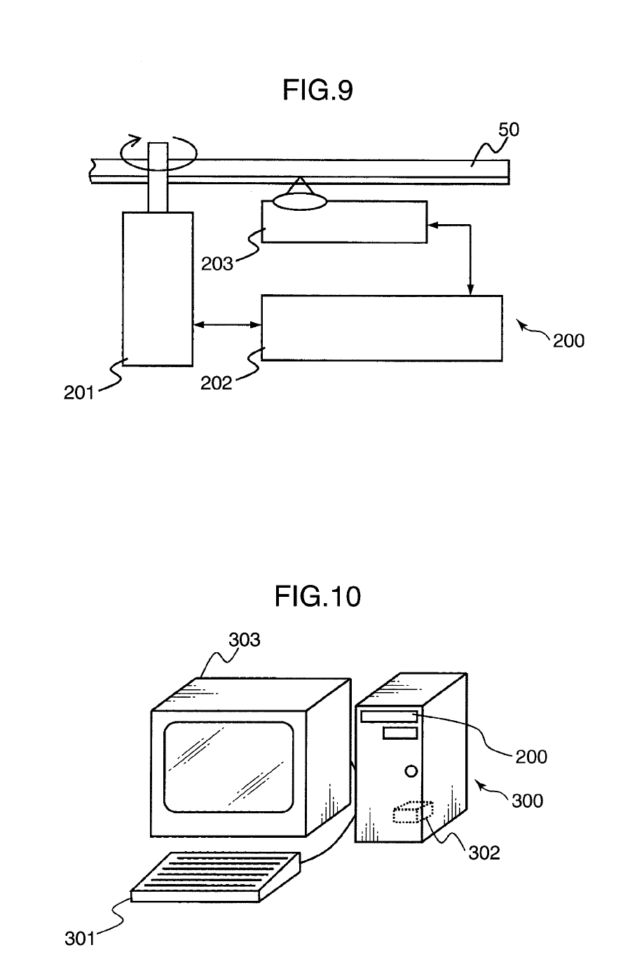

FIG. 9 shows a schematic configuration of the optical pickup device of Embodiment 2 of the present invention.

Referring to FIG. 9, an optical disc device 200 includes inside thereof an optical disc drive unit 201, a control unit 202, and an optical pickup device 203. In the configuration shown in FIG. 9, the optical disc device 200 has a BD 50 installed as an optical disc, but this disk can be replaced with a DVD 60 or a CD 70.

The optical disc drive unit 201 rotationally drives the BD 50 (or DVD 60 or CD 70). The optical pickup device 203 is the optical pickup device described in Embodiment 1. The control unit 202 controls the drive of the optical disc drive unit 201 and optical pickup device 203 and also conducts signal processing of control signals and information signals obtained by photoelectric conversion in the optical pickup device 203. The control unit 202 also conducts interface of information signals between the inside and outside of the optical disc device 200.

The control unit 202 receives control signals obtained from the optical pickup device 203 and conducts focus control, tracking control, information reproduction control, and rotational control of the optical disc drive unit 201 on the basis of the control signals. Further, the control unit 202 reproduces information from the information signals and transmits the recording signal to the optical pickup device 203.

The optical disc device 200 has installed therein the optical pickup device described in Embodiment 1. Therefore, the optical disc device 200 in Embodiment 2 can advantageously record information on optical discs of a plurality of kinds or reproduce information therefrom.

### Embodiment 3

FIG. 10 shows a schematic configuration of a computer of Embodiment 3 of the present invention.

Referring to FIG. 10, a computer 300 includes the optical disc device 200 of Embodiment 2, an input device 301 such as a keyboard, a mouse, or a touch panel for inputting information, a computational device 302 such as a central processing unit (CPU) for conducting computations on the basis of information inputted from the input device 301 or information read from the optical disc device 200, and an output device 303 such as a cathode-ray tube or a liquid crystal display device that displays information such as the results obtained by computations in the computational unit 302, or a printer that prints out the information.

The computer 300 has installed therein the optical disc device 200 described in Embodiment 2. Therefore, the computer can advantageously record information on optical discs of a plurality of kinds or reproduce information therefrom and has a wide field range of applications.

### Embodiment 4

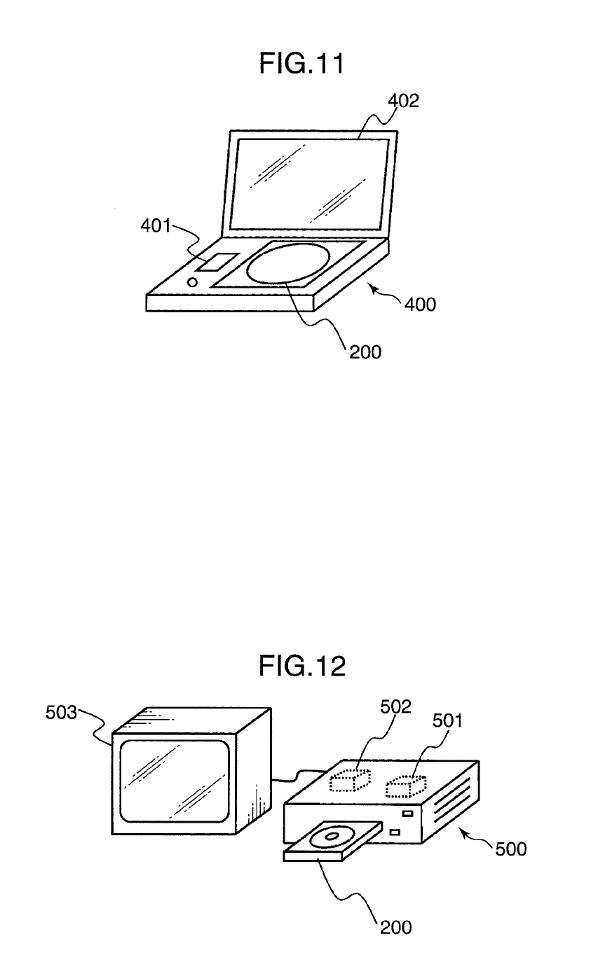

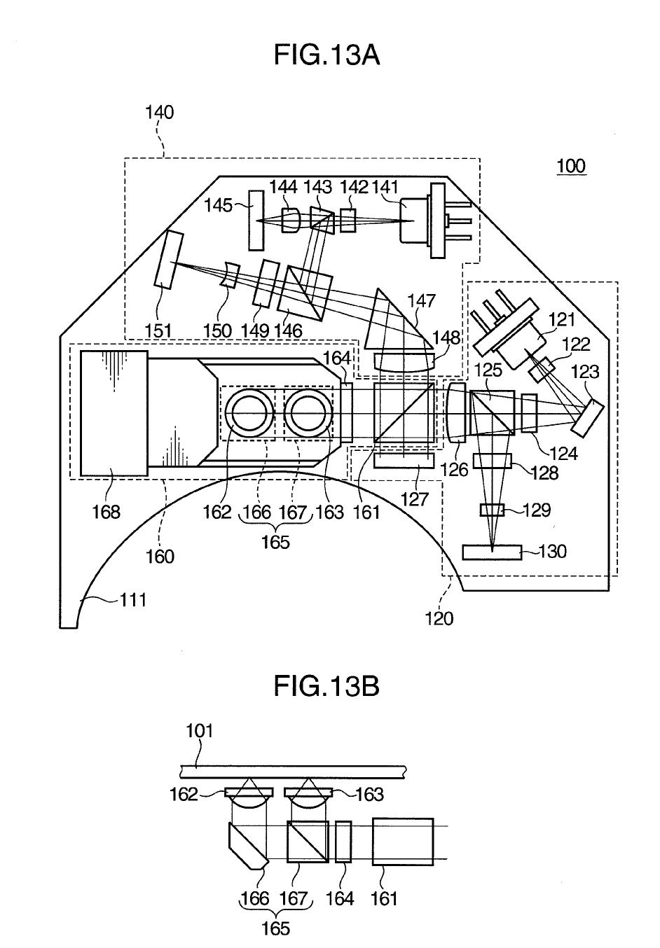

FIG. 11 is a schematic diagram of an optical disc player of Embodiment 4 of the present invention.

Referring to FIG. 11, the optical disc player 400 is provided with the optical disc device 200 of Embodiment 2 and a decoder 401 that converts information signals obtained from the optical disc device 200 into image signals.

The optical disc player 400 can be also used as a car navigation system by adding a position sensor such as GPS or a central processing unit (CPU). A display device 402 such as a liquid crystal monitor can be also added thereto.

The optical disc player 400 has installed therein the optical disc device 200 described in Embodiment 2. Therefore, the optical disc player can advantageously record information on optical discs of a plurality of kinds or reproduce information therefrom and has a wide field range of applications.

### Embodiment 5

FIG. 12 is a schematic diagram of an optical disc recorder of Embodiment 5 of the present invention.

Referring to FIG. 12, the optical disc recorder 500 is provided with the optical disc device 200 of Embodiment 2 and an encoder 501 that converts image information into information signal to be recorded on an optical disc by the optical disc device 200. It is desirable that a decoder 502 that converts information signals obtained from the optical disc device 200 into image signals be also provided. In such case the recorded images can be reproduced. The optical disc recorder 500 may be also provided with an output device 503 such as a cathode-ray tube or a liquid crystal display device that displays information, or a printer that prints out the information.

The optical disc recorder 500 has installed therein the optical disc device 200 described in Embodiment 2. Therefore, the optical disc recorder can advantageously record information on optical discs of a plurality of kinds or reproduce information therefrom and has a wide field range of applications.

The above-described specific embodiments mainly include the invention having the following features.

The optical pickup device according to one aspect of the present invention is an optical pickup device that reproduces or records information from or on optical information recording media of at least three kinds, the optical pickup device including: a first light source that emits a first light flux with a first wavelength; a second light source that emits a second light flux with a second wavelength that is different from the first wavelength and a third light flux with a third wavelength that is different from the first wavelength and the second wavelength; a light collection unit that collects the first to third light fluxes as converged light on the optical information recording medium, and a detection unit that detects the reflected light fluxes from the optical information recording medium, wherein the detection unit includes a first quartered light-receiving unit that receives a light flux obtained by reflection of at least one light flux from among the first to third light fluxes from the optical information recording medium and a second quartered light-receiving unit that receives a light flux obtained by reflection of the remaining light fluxes from the optical information recording medium.

With such a configuration, a first light flux with a first wavelength is emitted by the first light source, and a second light flux with a second wavelength that is different from the first wavelength and a third light flux with a third wavelength that is different from the first wavelength and the second wavelength is emitted by the second light source. The light collection unit collects the first to third light fluxes as converged light on the optical information recording medium, and the detection unit detects the reflected light fluxes from the optical information recording medium. Further, the detection unit includes the first quartered light-receiving unit and the second quartered light-receiving unit. The first quartered light-receiving unit receives a light flux obtained by reflection of at least one light flux from among the first to third light fluxes from the optical information recording medium, and the second quartered light-receiving unit receives a light flux obtained by reflection of the remaining light fluxes from the optical information recording medium.

Therefore, the optical system from the stage of collecting the first to third light fluxes as converged light on the optical information recording medium to the stage of detecting the reflected light beams from the optical information recording and the detector that detects the reflected light fluxes can be commonly used with the first to third light fluxes. Therefore, the number of components can be greatly reduced, the device can be made compatible with optical discs of at least three kinds, and size reduction can be realized.

In the above-described optical pickup device, it is preferred that the first quartered light-receiving unit receive a light flux obtained by reflection of the light flux with the longest wavelength from the optical information recording medium and receive a light flux obtained by reflection of the light flux with the shortest wavelength from the optical information recording medium from among the first to third light fluxes, and the second quartered light-receiving unit receive the light flux obtained by reflection of the light flux with the remaining wavelength from the optical information recording medium.

With such a configuration, the light flux obtained by reflection of the light flux with the longest wavelength from the optical information recording medium and the light flux obtained by reflection of the light flux with the shortest wavelength from the optical information recording medium from among the first to third light fluxes are received by the first quartered light-receiving unit, and the light flux obtained by reflection of the light flux with the remaining wavelength from the optical information recording medium is received by the second quartered light-receiving unit.

Therefore, the light flux obtained by reflection of the light flux with the longest wavelength from the optical information recording medium and the light flux obtained by reflection of the light flux with the shortest wavelength from the optical information recording medium from among the first to third light fluxes can be received by the same first quartered light-receiving unit, and the light flux obtained by reflection of the light flux with the remaining wavelength from the optical information recording medium can be received by the second quartered light-receiving unit. Further, because the surface area of the first quartered light-receiving unit can be reduced correspondingly to the diameter of the first light flux, a high-quality signal with low noise can be obtained and a useful characteristic can be obtained during reproduction of optical discs with a low reflection ratio or high-speed reproduction.

In the above-described optical pickup device, it is preferred that the light collection unit include a collimator lens that makes the first to third light fluxes into substantially parallel fluxes, a first objective lens that collects the first light flux, and a second objective lens that collects at least the second and third light fluxes, and the focal distance of the first objective lens be less than the focal distance of the second objective lens.

With such a configuration, the first to third light fluxes are made into almost parallel fluxes by the collimator lens, the first light flux is collected by the first objective lens, and at least the second and third light fluxes are collected by the second objective lens. Further, the focal distance of the first objective lens is less than the focal distance of the second objective lens.

Therefore, because the focal distance of the first objective lens is designed to be less than the focal distance of the second objective lens, the diameters of the first to third light fluxes in the detection unit can be optimized.

In the above-described optical pickup device, it is preferred that the first quartered light-receiving unit be smaller that the second quartered light-receiving unit. With such a configuration, because the first quartered light-receiving unit is smaller that the second quartered light-receiving unit, the detection unit can be miniaturized.

In the above-described optical pickup device, it is preferred that the light collection unit include a first mirror that guides the first light flux to the first objective lens and a second mirror that guides at least the second or third light flux to the second objective lens; the second mirror transmit the first light flux and reflects at least the second and third light flux, and the first mirror and the second mirror be disposed so that reflective surfaces have a predetermined relative angle.

With such a configuration, the first light flux is guided to the first objective lens by the first mirror, and at least the second or third light flux is guided to the second objective lens by the second mirror. The second mirror transmits the first light flux and reflects at least the second light flux and the third light flux. The first mirror and second mirror are disposed with inclination such that the reflective surfaces have a predetermined relative angle.

Therefore, the optical axis of the first light flux falling on the first objective lens is made parallel to the optical axis of the second light flux falling on the second objective lens, and the optical axis of the first light flux falling on the detection unit is matched with the optical axis of the third light flux.

In the above-described optical pickup device, it is preferred that the first wavelength be 380 to 430 nm, the second wavelength be 640 to 690 nm, and the third wavelength be 750 to 820 nm, and the second light source be constituted by a single light-emitting element that emits the second light flux or the third light flux.

With such a configuration, the first wavelength is 380 to 430 nm, the second wavelength is 640 to 690 nm, and the third wavelength is 750 to 820 nm. Further, the second light source is constituted by a single light-emitting element that emits the second light flux and the third light flux. Therefore, the optical pickup device can be reduced in size by comparison with the configuration in which the light source that emits the second light flux and the light source that emits the third light flux are constituted by different light-emitting elements.

In the above-described optical pickup device, it is preferred that the light collection unit include an optical branching element that reflects the first light flux that has been emitted from the first light source, transmits a reflected light flux from the optical information recording medium of the first light flux, reflects the second light flux or the third light flux that has been emitted from the second light source, and transmits a reflected light flux from the optical information recording medium of the second light flux or the third light flux.

With such a configuration, the optical branching element reflects the first light flux that has been emitted from the first light source, transmits a light flux obtained by reflection of the first light flux from the optical information recording medium, reflects the second light flux or the third light flux that has been emitted from the second light source, and transmits a light flux obtained by reflection of the second light flux or the third light flux from the optical information recording medium.

Therefore, the first to third light fluxes emitted from the first and second light sources can be guided in the same direction, and the light fluxes obtained by reflection of the first to third light fluxes from the optical information recording medium can be guided to the detection unit.

An optical disc device according to another aspect of the present invention includes the above-described optical pickup device; a motor that rotationally drives the optical information recording medium, and a control unit that controls the optical pickup device and the motor. With such a configuration, the above-described optical pickup device can be applied to an optical disc device.

A computer according to another aspect of the present invention includes the above-described optical disc device, an input unit that inputs information, a computational unit that performs a computation on the basis of information reproduced by the optical disc device and/or information inputted by the input unit, and an output unit that outputs information reproduced by the optical disc device, information inputted by the input unit, and/or a result of the computation performed by the computational unit.

With such a configuration, information is inputted by the input unit, and the computation is performed by the computational unit on the basis of information reproduced by the optical disc device and/or information inputted by the input unit. Information reproduced by the optical disc device, information inputted by the input unit, and/or a result of the computation performed by the computational unit is outputted by the output unit. Therefore, the optical disc device including the above-described optical pickup device can be applied to a computer.

An optical disc player according to another aspect of the present invention includes the above-described optical disc device, an input unit that inputs information, and a decoder that converts an information signal obtained from the optical disc device into image information.

With such a configuration, an information signal obtained from the optical disc device is converted into image information by the decoder. Therefore, the optical disc device including the above-described optical pickup device can be applied to an optical disc player.

An optical disc recorder according to another aspect of the present invention includes the above-described optical disc device and an encoder that converts image information into information signals for recording with the optical disc device.

With such a configuration, image information is converted by the encoder into information signals for recording with the optical disc device. Therefore, the optical disc device including the above-described optical pickup device can be applied to an optical disc recorder.

### INDUSTRIAL APPLICABILITY

The optical pickup device, optical disc device, computer, optical disc player, and optical disc recorder in accordance with the present invention are compatible with optical information recording media of at least three kinds, make it possible to realize size reduction, and are useful for optical pickup devices, optical disc devices, computers, optical disc players, and optical disc recorders that optically record or reproduce information.

1. An optical pickup device that reproduces or records information from or on optical information recording media of at least three kinds,
the optical pickup device comprising:
a first light source that emits a first light flux with a first wavelength (380 to 430 nm);
a second light source that emits a second light flux with a second wavelength (640 to 690 nm) that is different from the first wavelength and a third light flux with a third wavelength (750 to 820 nm) that is different from the first wavelength and the second wavelength;
a light collection unit that collects the first to third light fluxes as converged light on the optical information recording medium;
a first optical branching element that guides the first light flux to the light collection unit;
a second optical branching element that guides the second light flux and the third light flux to the light collection unit, and
a detection unit that detects the first to third light fluxes reflected by the optical information recording medium, wherein
the detection unit includes a first quartered light-receiving unit that receives a light flux obtained by reflection of at least one light flux from among the first to third light fluxes from the optical information recording medium and a second quartered light-receiving unit that receives a light flux obtained by reflection of the remaining light fluxes from the optical information recording medium,
the first light source is disposed on a side closer to the light collection unit than the second light source, and
the first light flux emitted from the first light source is reflected by the first optical branching element, guided to the light collection unit, and reflected by the optical information recording medium, and transmitted through the first optical branching element and the second optical branching element, and then guided to the detector.

2. The optical pickup device according to claim 1, wherein
the first quartered light-receiving unit receives, from among the first to third light fluxes, a light flux obtained by reflection of the light flux with the longest wavelength from the optical information recording medium and receives a light flux obtained by reflection of the light flux with the shortest wavelength from the optical information recording medium, and
the second quartered light-receiving unit receives a light flux obtained by reflection of the light flux with the remaining wavelength from the optical information recording medium.

3. The optical pickup device according to claim 1, wherein
the light collection unit includes a collimator lens that makes the first to third light fluxes into substantially parallel fluxes, a first objective lens that collects the first light flux, and a second objective lens that collects at least the second and third light fluxes, and
a focal distance of the first objective lens is less than a focal distance of the second objective lens.

4. The optical pickup device according to claim 1, wherein the first quartered light-receiving unit is smaller that the second quartered light-receiving unit.

5. The optical pickup device according to claim 3, wherein
the light collection unit includes a first mirror that guides the first light flux to the first objective lens and a second mirror that guides at least the second or third light flux to the second objective lens;
the second mirror transmits the first light flux and reflects at least the second and third light flux, and
the second mirror is disposed to be inclined so as to have a predetermined relative angle with respect a reflective surface of the first mirror.

6. The optical pickup device according to claim 1, wherein
the second light source is constituted by a single light-emitting element that emits the second light flux and the third light flux.

7. (canceled)

8. An optical disc device comprising:
the optical pickup device according to claim 1;
a motor that rotationally drives the optical information recording medium, and
a control unit that controls the optical pickup device and the motor.

9. A computer comprising:
the optical disc device according to claim 8;
an input unit that inputs information;
a computational unit that performs a computation on the basis of information reproduced by the optical disc device and/or information inputted by the input unit, and
an output unit that outputs information reproduced by the optical disc device, information inputted by the input unit, and/or a result of the computation performed by the computational unit.

10. An optical disc player comprising:
the optical disc device according to claim 8, and
a decoder that converts an information signal obtained from the optical disc device into image information.

11. An optical disc recorder comprising:
the optical disc device according to claim 8, and
an encoder that converts image information into information signals for recording by the optical disc device.
